(19) United States
(12) Patent Application Publication
(10) Pub. No.: US 2009/0047804 A1
(43) Pub. Date: Feb. 19, 2009

(54) SURFACE-MOUNT CONNECTOR AND CIRCUIT BOARD ASSEMBLY INTERCONNECTED BY SAME

(75) Inventors: Chin-Chi Kuo, Taoyuan Hsien (TW); Chi-Ming Chin, Taoyuan Hsien (TW)

Correspondence Address: KIRTON AND MCCONKIE, 60 EAST SOUTH TEMPLE,, SUITE 1800, SALT LAKE CITY, UT, 84111, US

(73) Assignee: DELTA ELECTRONICS, INC., Taoyuan Hsien (TW)

(21) Appl. No.: 11/958,948

(22) Filed: Dec. 18, 2007

(30) Foreign Application Priority Data
Aug. 13, 2007 (TW) 096129862

(51) Int. Cl. H01R 12/00

(52) U.S. Cl. 439/65

(57) ABSTRACT

The present invention relates to a surface-mount connector for electrically interconnecting a first circuit board and a second circuit board. The surface-mount connector includes a first connecting part, a second connecting part and a sidewall. The first connecting part is bonded onto the first circuit board. The second connecting part has a conductive surface bonded onto the second circuit board. The sidewall has a first end axially extended from a periphery of the second connecting part and a second end being formed as at least a portion of the first connecting part.

### FIELD OF THE INVENTION

The present invention relates to a connector, and more particularly to a surface-mount connector. The present invention also relates to a circuit board assembly having two circuit boards interconnected by such a surface-mount connector.

### BACKGROUND OF THE INVENTION

With increasing of electronic industries, the electronic devices are developed toward minimization, high operating speed and increasing integration level. As a consequence, the requirement of increasing the pin density of the semiconductor packages becomes more important. A connector, for example, a conductive pin is widely used to electrically and/or structurally interconnect two circuit boards.

Currently, by using a surface mount technology (SMT), the circuits or electronic components on two circuit boards are electrically connected with each other via this type of surface-mount connector. Please refer to FIGS. 1(a) and 1(b), which are respectively schematic perspective and cross-sectional views of two circuit boards interconnected by multiple surface-mount connectors. As shown in FIGS. 1(a) and 1(b), the circuit board assembly 1 includes a first circuit board 11 and a second circuit board 12. Several electronic components 111 and 121 are disposed on the first circuit board 11 and the second circuit board 12, respectively. For a purpose of electrically and/or structurally connecting the first circuit board 11 with the second circuit board 12, solder paste 14 is firstly applied to predetermined contact pads on the lower side of the first circuit board 11. Then, the conductive pins 13 are placed on the contact pads of the first circuit board 11. After the first circuit board 11 passes through a reflow furnace (not shown), the conductive pins 13 are securely bonded to the contact pads on the first circuit board 11. Then, solder paste 14 is applied to predetermined contact pads on the upper side of the second circuit board 12 and the conductive pins 13 are placed on the contact pads of the second circuit board 12. After the first circuit board 11 and the second circuit board 12 passes through the reflow furnace (not shown), the conductive pins 13 are securely bonded onto the first circuit board 11 and the second circuit board 12. Meanwhile, the electronic components 111 on the first circuit board 11 and the electronic components 121 on the second circuit board 12 are electrically connected to each other through the conductive pins 13 (i.e. the surface-mount connectors).

Moreover, for facilitating securely fixing the surface-mount connectors 13 onto the first circuit board 11 and the second circuit board 12, the upper and lower ends of the surface-mount connectors 13 needs to have wavy or curvy surfaces.

The structure of FIG. 1, however, still has some drawbacks. For example, since it is difficult to control the thickness of the solder paste 14, the lower surfaces of the surface-mount connectors 13 are usually not coplanar after the upper surfaces of these surface-mount connectors 13 are bonded on the first circuit 11. In addition, since the surface-mount connectors 13 are substantially solid rods, the lengths of the relatively longer and shorter surface-mount connectors 13 fail to be adjusted to be at the same levels. Under this circumstance, some surface-mount connectors 13 fail to be in close contact with the solder paste 14 coated on the second circuit board 12 and thus are often suffered from poor solderability. Therefore, the electrical connection and the structural stability between the first circuit 11 and the second circuit board 12 are impaired, and the product yield is reduced.

In views of the above-described disadvantages resulted from the prior art, the applicant keeps on carving unflaggingly to develop a surface-mount connector for use with a circuit board assembly according to the present invention through wholehearted experience and research.

### SUMMARY OF THE INVENTION

It is an object of the present invention to provide a surface-mount connector for use with a circuit board assembly in order to avoid the problem of causing poor solderability.

Another object of the present invention provides a surface-mount connector for electrically and/or structurally interconnecting two circuit boards, thereby increasing the product yield.

In accordance with an aspect of the present invention, there is provided a surface-mount connector for electrically interconnecting a first circuit board and a second circuit board. The surface-mount connector includes a first connecting part, a second connecting part and a sidewall. The first connecting part is bonded onto the first circuit board. The second connecting part has a conductive surface bonded onto the second circuit board. The sidewall has a first end axially extended from a periphery of the second connecting part and a second end being formed as at least a portion of the first connecting part.

In an embodiment, the conductive surface is a curved convex surface protruded toward the second circuit board.

In an embodiment, the first connecting part further includes at least a protruding edge for increasing a contact area between the first connecting part and the first circuit board.

In an embodiment, the periphery of the second connecting part is fully surrounded by the sidewall such that the surface-mount connector is substantially a hollow cylindrical tube.

In an embodiment, the periphery of the second connecting part is partially surrounded by the sidewall.

In an embodiment, the sidewall is symmetrically extended from the periphery of the second connecting part.

Preferably, the surface-mount connector is made of ductile conductive material such as metallic material, for example copper.

In an embodiment, the surface-mount connector is bonded onto the first circuit board and the second circuit board via a connecting medium.

In accordance with another aspect of the present invention, there is provided a circuit board assembly. The circuit board assembly includes a first circuit board, a second circuit board and a plurality of surface-mount connectors. The surface-mount connectors are arranged between the first circuit board and the second circuit board for electrically interconnecting the first circuit board and the second circuit board. Each surface-mount connector comprising a first connecting part, a second connecting part and a sidewall. The first connecting part is bonded onto the first circuit board. The second connecting part includes a conductive surface bonded onto the second circuit board. The sidewall has a first end axially extended from a periphery of the second connecting part and a second end being formed as at least a portion of the first connecting part. The conductive surface of the second connecting part of the surface-mount connector is optionally subject to deformation so as to reduce the height difference between any two surface-mount connectors.

The above contents of the present invention will become more readily apparent to those ordinarily skilled in the art after reviewing the following detailed description and accompanying drawings, in which:

### BRIEF DESCRIPTION OF THE DRAWINGS

FIG. 1(a) is a schematic perspective view illustrating two circuit boards interconnected by multiple surface-mount connectors according to prior art;

FIG. 1(b) is a cross-sectional view of FIG. 1(a);

FIG. 2(a) is a schematic perspective view illustrating a circuit board assembly according to a first preferred embodiment of the present invention;

FIG. 2(b) is a schematic perspective view of one surface-mount connector in FIG. 2(a);

FIG. 2(c) is a cross-sectional view of the surface-mount connector in FIG. 2(a) take along the line A′-A′;

FIG. 2(d) is an exploded view of the circuit board assembly of FIG. 2(a);

FIG. 2(e) is a side view of the circuit board assembly of FIG. 2(a);

FIG. 3(a) is a schematic perspective view of a surface-mount connector according to a second preferred embodiment of the present invention;

FIG. 3(b) is a cross-sectional view of the surface-mount connector in FIG. 3(a) take along the line A′-A′;

FIG. 3(c) is a schematic side view illustrating two circuit boards interconnected by multiple surface-mount connectors of FIG. 3(a);

FIG. 4(a) is a schematic perspective view illustrating a circuit board assembly according to a third preferred embodiment of the present invention;

FIG. 4(b) is a schematic perspective view of one surface-mount connector in FIG. 4(a);

FIG. 4(c) is a cross-sectional view of the surface-mount connector in FIG. 4(a) take along the line A′-A′;

FIG. 4(d) is an exploded view of the circuit board assembly of FIG. 4(a);

FIG. 4(e) is a side view of the circuit board assembly of FIG. 4(a);

FIG. 5(a) is a schematic perspective view of a surface-mount connector according to a fourth preferred embodiment of the present invention; and

FIG. 5(b) is a cross-sectional view of the surface-mount connector in FIG. 5(a) take along the line A′-A′.

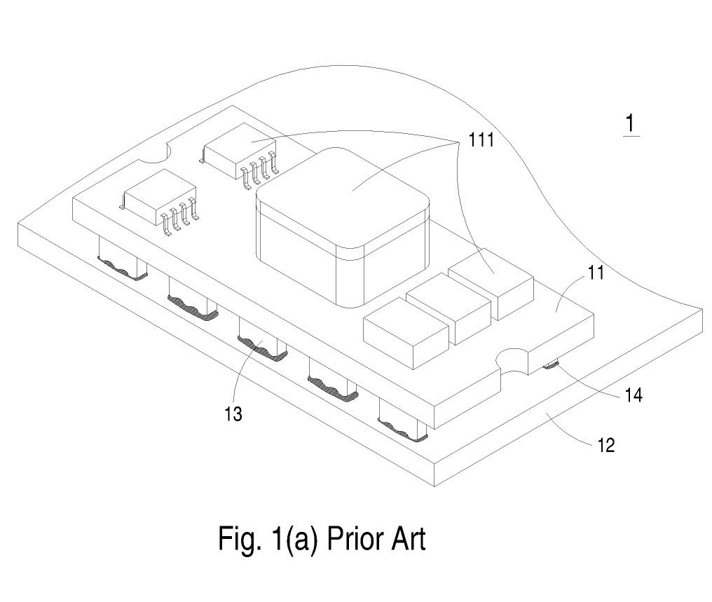

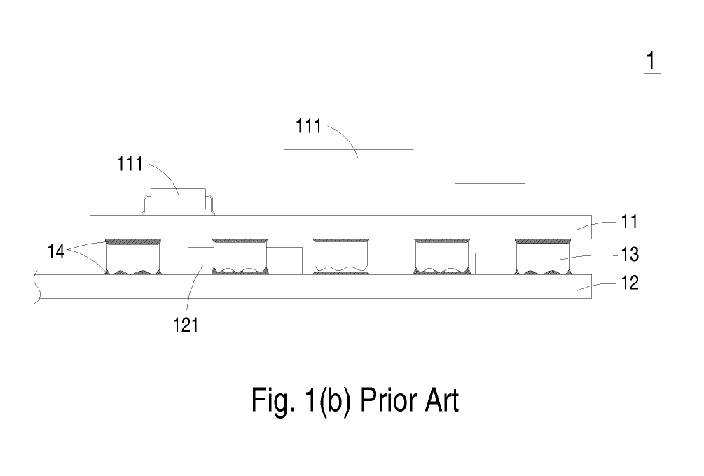

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

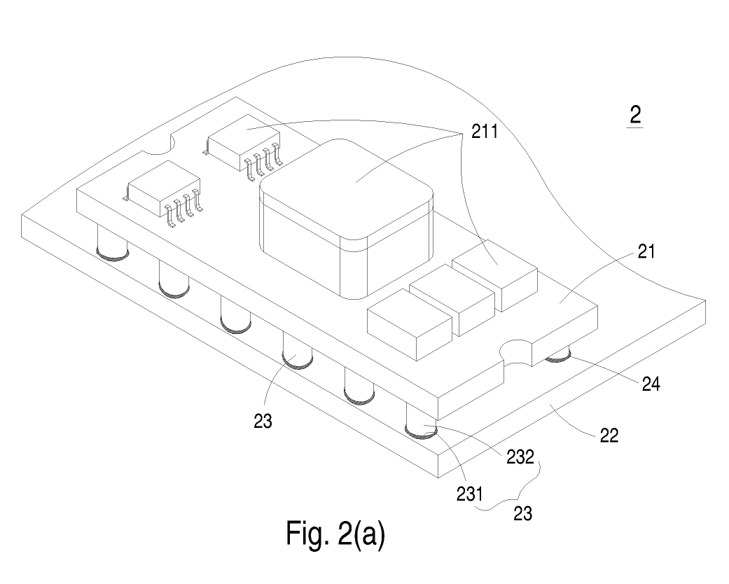

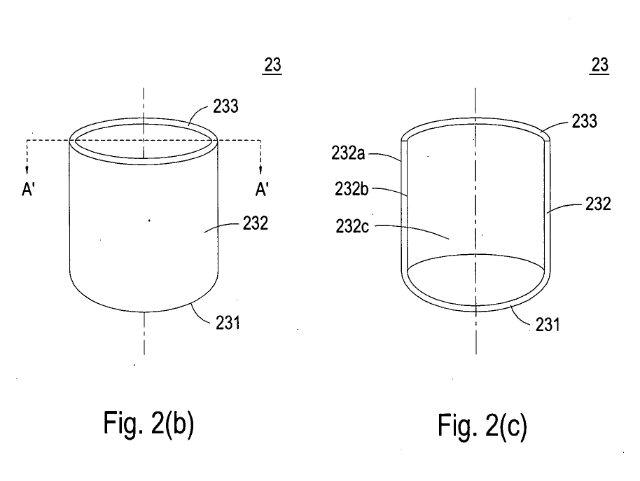

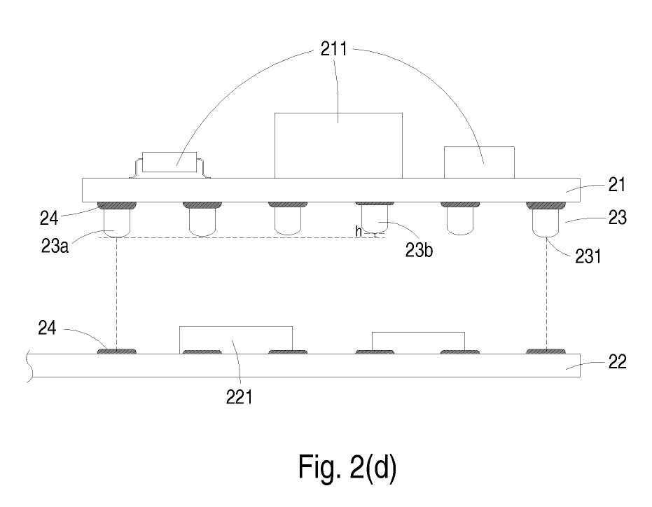

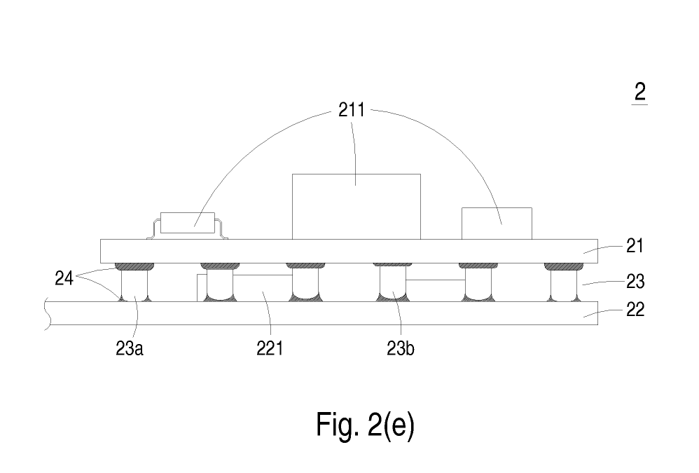

Referring to FIG. 2(a), a schematic assembled view of a circuit board assembly according to a first preferred embodiment of the present invention is illustrated. The circuit board assembly 2 includes a first circuit board 21, a second circuit board 22 and a plurality of surface-mount connectors 23. The first circuit board 21 and the second circuit board 22 are substantially parallel with each other. The surface-mount connectors 23 are made of conductive material for interconnecting the first circuit board 21 and the second circuit board 22. As shown in FIG. 2(a), several electronic components 211 including resistors, capacitors, chips and the like are mounted on the first circuit board 21. Likewise, several electronic components 221 are mounted on the second circuit board 22 (as shown in FIGS. 2(d) and 2(e)). Moreover, the contact pads on corresponding locations of the first circuit board 21 and the second circuit board 22 are coated with a connecting medium 24 such as solder paste. Via the connecting medium 24, the surface-mount connectors 23 are firmly bonded onto the first circuit board 21 and the second circuit board 22 and the first circuit board 21 and the second circuit board 22 are electrically connected with each other.

FIGS. 2(b) and 2(c) are schematic perspective and cross-sectional views of one surface-mount connector in FIG. 2(a), respectively. The surface-mount connector 23 principally includes a second connecting part 231 and a sidewall 232, which are integrally formed into one-piece. The sidewall 232 is extended axially from the periphery of the second connecting part 231. The upper portion of the sidewall 232 is formed as at least a portion of the first connecting part 233. The second connecting part 231 is a substantially a conductive surface of an arbitrary shape (e.g. a circular shape, an elliptic shape or a polygonal shape). In addition, the second connecting part 231 is also a conductive surface having an annular surface. The first connecting part 233 and the second connecting part 231 are respectively bonded onto the lower side of the first circuit board 21 and the upper side of the second circuit board 22 via the connecting medium 24.

Please refer to FIGS. 2(b) and 2(c) again. In this embodiment, the surface-mount connector 23 is made of ductile conductive material such as metallic material, for example copper. In this embodiment, the second connecting part 231 has a circular profile. Especially, the second connecting part 231 has a curved convex surface, which is advantageous for minimizing formation of holes during soldering. In other words, the surface-mount connector 23 of this embodiment is substantially a hollow cylindrical tube with a U-shaped cross-section, as is shown in FIG. 2(c).

As previously described, the lower surfaces of the surface-mount connectors 23 are usually not coplanar after the upper surfaces of these surface-mount connectors 23 are bonded on the first circuit 21. That is, there is often a height difference h between two adjacent surface-mount connectors 23, as can be seen in FIG. 2(d). In accordance with a specific feature of the present invention, a slight external force may be applied on the second connecting parts 231 by means of a press tool after the upper surfaces of these surface-mount connectors 23 are bonded on the first circuit board 21. Since the surface-mount connectors 23 of this embodiment are designed as hollow cylindrical tubes and made of ductile material, the second connecting parts 231 of the relatively longer surface-mount connectors 23a will be subject to deformation in response to the external force. In other words, the curved convex surfaces of the second connecting parts 231 will be concaved inwardly, so that the height difference between any two surface-mount connectors is reduced. Under this circumstance, the lower portions of the relatively longer surface-mount connectors 23a and the relatively shorter surface-mount connectors 23b are nearly coplanar. As a consequence, after the first circuit board 21 and the second circuit board 22 pass through a reflow furnace (not shown), the solder paste 24 will be naturally filled in a gap between the curved convex surfaces of the relatively shorter surface-mount connectors 23b and the second circuit board 22 due to capillary attraction resulted from the connecting medium 24 such as the molten solder paste. In other words, the curved convex surfaces of the relatively shorter surface-mount connectors 23b is advantageous for minimizing formation of holes during soldering, and thus all surface-mount connectors 23 are firmly bonded on the second circuit board 22. As a consequence, the first circuit board 21 is electrically connected to the second circuit board 22 via these surface-mount connectors 23.

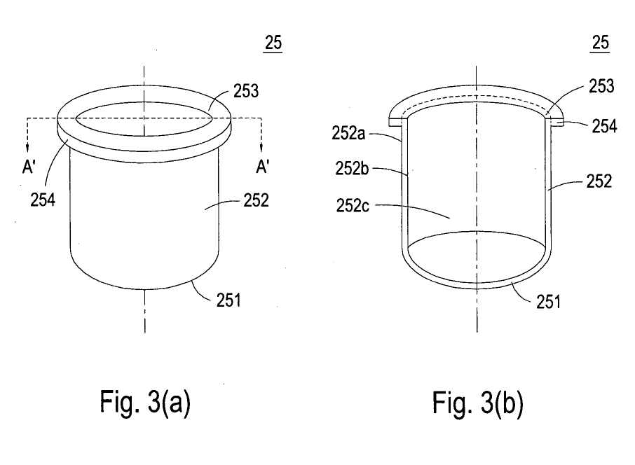

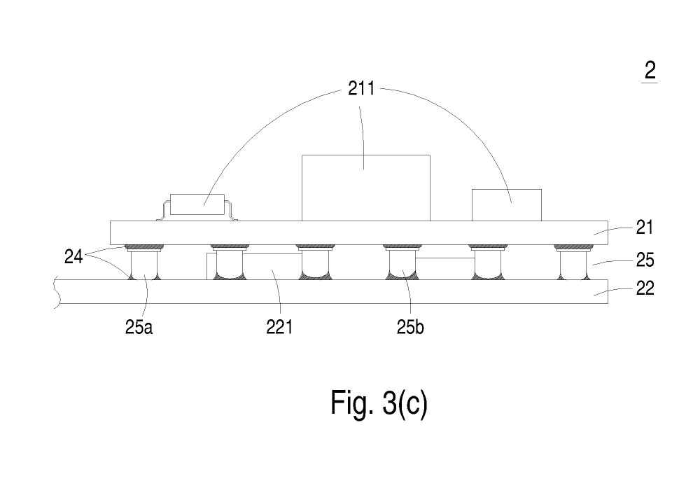

FIGS. 3(a) and 3(b) are respectively schematic perspective and cross-sectional views of a surface-mount connector according to a second preferred embodiment of the present invention. In this embodiment, the second connecting part 251 and the sidewall 252 included therein are similar to those shown in FIG. 3(b), and are not redundantly described herein. In addition, the first connecting part 253 of the surface-mount connector 25 has at least a protruding edge 254 extended outwardly from the upper peripheral of the sidewall 252. Similarly, the surface-mount connector 25 is substantially a hollow cylindrical tube with a U-shaped cross-section and a protruding edge 254, as is shown in FIG. 3(b).

FIG. 3(c) is a cross-sectional view illustrating the first and second circuit boards interconnected by the surface-mount connector of FIG. 3(a). As shown in FIG. 3(c), the protruding edge 254 may facilitate increasing a contact area between the first connecting part 253 and the first circuit board 21. Due to the cylindrical tube structure, the surface-mount connector 25 has the advantages as described in the first preferred embodiment. On the other hand, due to the protruding edge 254, the contact area between the first connecting part 253 and the first circuit board 21 is increased and the adhesion of the surface-mount connectors 25 to the first circuit board 21 is enhanced.

It is noted that, however, those skilled in the art will readily observe that numerous modifications and alterations of the surface-mount connector may be made while retaining the teachings of the invention. For example, the protruding edge 254 may be extended inwardly from the upper peripheral of the sidewall 252. In addition, the second connecting part 251 is a substantially a conductive surface of an arbitrary shape such as a circular shape, an elliptic shape or a polygonal shape.

As previously described, the lower surfaces of the surface-mount connectors 25 are usually not coplanar after the upper surfaces of these surface-mount connectors 25 are bonded on the first circuit 21. That is, there is often a height difference between two adjacent surface-mount connectors 25. In accordance with a specific feature of the present invention, a slight external force may be applied on the second connecting parts 251 by means of a press tool after the upper surfaces of these surface-mount connectors 25 are bonded on the first circuit board 21. Since the surface-mount connectors 25 of this embodiment are designed as hollow cylindrical tubes and made of ductile material, the second connecting parts 251 of the relatively longer surface-mount connectors 25a will be subject to deformation in response to the external force. In other words, the curved convex surfaces of the second connecting parts 251 will be concaved inwardly, so that the height difference between any two surface-mount connectors is reduced. Under this circumstance, the lower portions of the relatively longer surface-mount connectors 25a and the relatively shorter surface-mount connectors 25b are nearly coplanar. As a consequence, after the first circuit board 21 and the second circuit board 22 pass through a reflow furnace (not shown), the solder paste 24 will be naturally filled in a gap between the curved convex surfaces of the relatively shorter surface-mount connectors 25b and the second circuit board 22 due to capillary attraction resulted from the connecting medium 24 such as the molten solder paste. In other words, the curved convex surfaces of the relatively shorter surface-mount connectors 25b is advantageous for minimizing formation of holes during soldering, and thus all surface-mount connectors 25 are firmly bonded on the second circuit board 22. As a consequence, the first circuit board 21 is electrically connected to the second circuit board 22 via these surface-mount connectors 25.

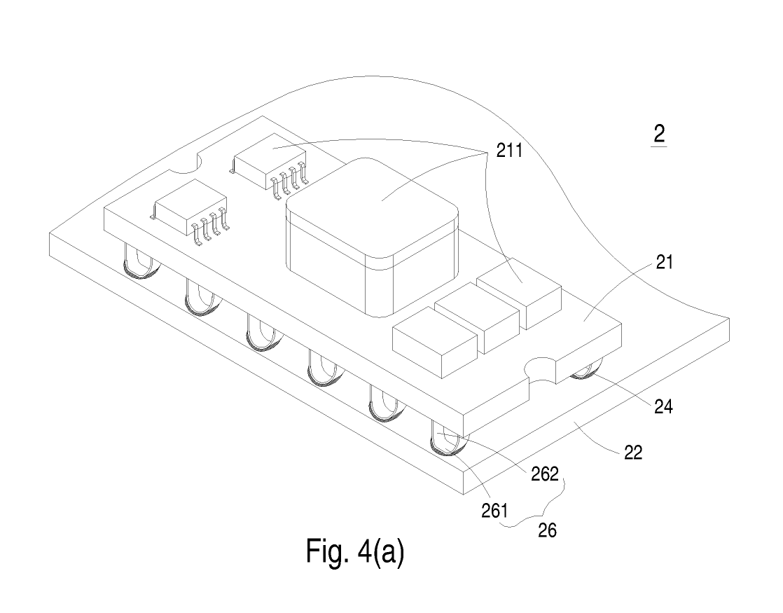

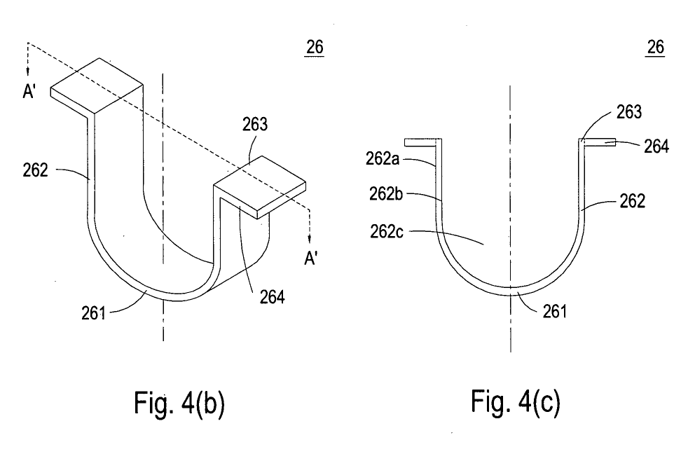

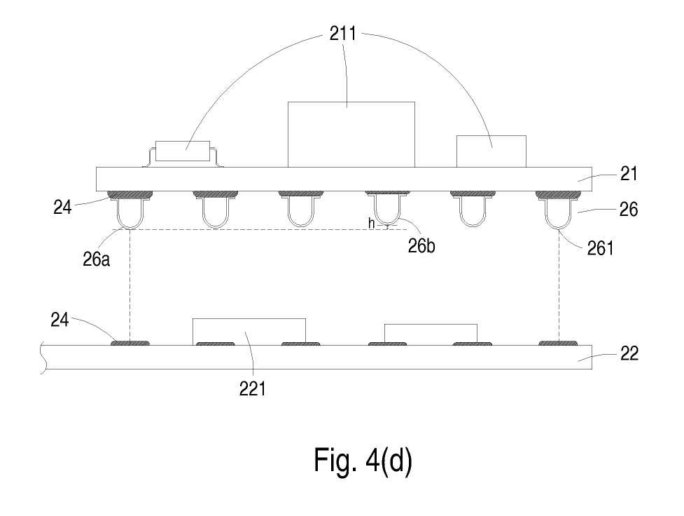

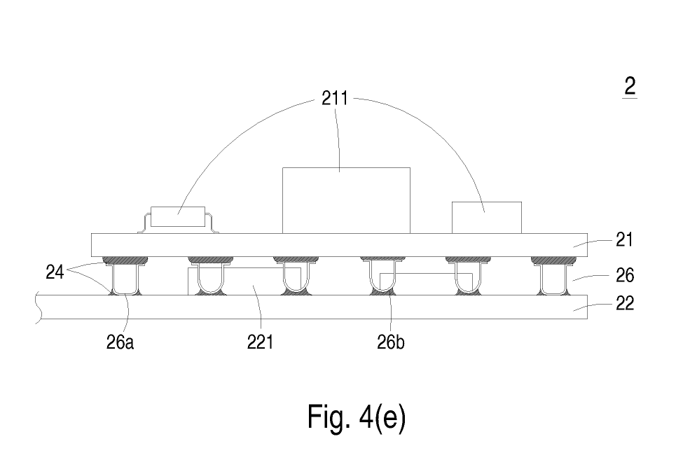

Referring to FIG. 4(a), a schematic assembled view of a circuit board assembly according to a third preferred embodiment of the present invention is illustrated. The circuit board assembly 2 includes a first circuit board 21, a second circuit board 22 and a plurality of surface-mount connectors 26. The first circuit board 21 and the second circuit board 22 are substantially parallel with each other. Several electronic components 211 and 221 (as shown in FIGS. 4(d) and 4(e)) are mounted on the first circuit board 21 and the second circuit board 22, respectively. Via the connecting medium 24 (e.g. solder paste), the surface-mount connectors 26 are firmly bonded onto the first circuit board 21 and the second circuit board 22 and the first circuit board 21 and the second circuit board 22 are electrically connected with each other.

FIGS. 4(b) and 4(c) are schematic perspective and cross-sectional views of one surface-mount connector in FIG. 4(a), respectively. The surface-mount connector 26 principally includes a second connecting part 261 and a sidewall 262, which are integrally formed by bending a ductile metallic plate. The sidewall 262 is extended axially from the periphery of the second connecting part 261 and symmetrically arranged on bilateral side of the second connecting part 261. The upper portion of the sidewall 262 is formed as a first connecting part 263. Likewise, the second connecting part 261 has a curved convex surface, which is subject to deformation in response to a slight external force. In addition, the first connecting part 263 of the surface-mount connector 26 has at least a protruding edge 264 extended outwardly from the upper peripheral of the sidewall 262, thereby increasing the contact area between the first connecting part 263 and the first circuit board 21.

As previously described, the lower surfaces of the surface-mount connectors 26 are usually not coplanar after the upper surfaces of these surface-mount connectors 26 are bonded on the first circuit 21. That is, there is often a height difference h between two adjacent surface-mount connectors 26, as can be seen in FIG. 4(d). In accordance with a specific feature of the present invention, a slight external force may be applied on the second connecting parts 261 by means of a press tool after the upper surfaces of these surface-mount connectors 26 are bonded on the first circuit board 21. Since the surface-mount connectors 26 of this embodiment are designed have U-shaped plate structures and made of ductile material, the second connecting parts 261 of the relatively longer surface-mount connectors 26a will be subject to deformation in response to the external force. In other words, the curved convex surfaces of the second connecting parts 261 will be concaved inwardly, so that the height difference between any two surface-mount connectors is reduced. Under this circumstance, the lower portions of the relatively longer surface-mount connectors 26a and the relatively shorter surface-mount connectors 26b are nearly coplanar, as is shown in FIG. 4(e). As a consequence, after the first circuit board 21 and the second circuit board 22 pass through a reflow furnace (not shown), the solder paste 24 will be naturally filled in a gap between the curved convex surfaces of the relatively shorter surface-mount connectors 26b and the second circuit board 22 due to capillary attraction resulted from the molten solder paste 24. In other words, the curved convex surfaces of the relatively shorter surface-mount connectors 26b is advantageous for minimizing formation of holes during soldering, and thus all surface-mount connectors 26 are firmly bonded on the second circuit board 22.

It is noted that, however, those skilled in the art will readily observe that numerous modifications and alterations of the surface-mount connector may be made while retaining the teachings of the invention. For example, the protruding edge 264 of the surface-mount connector 26 may be extended inwardly from the upper peripheral of the sidewall 262. Alternatively, the protruding edge 264 may be dispensed with.

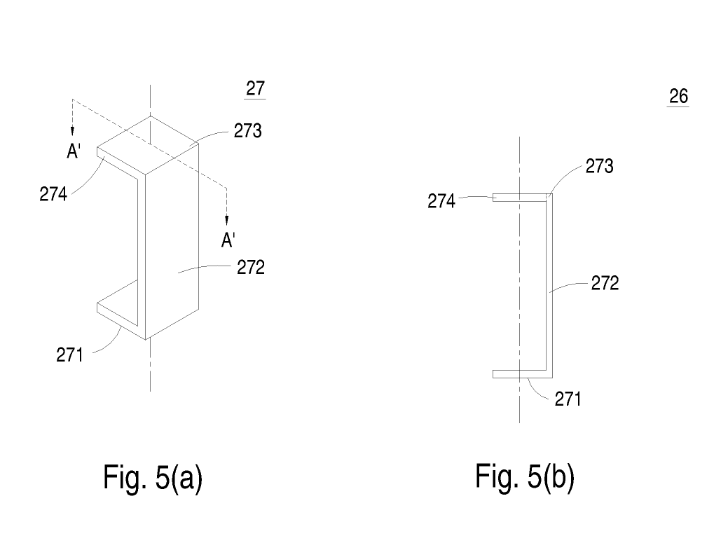

FIGS. 5(a) and 5(b) are respectively schematic perspective and cross-sectional views of a surface-mount connector according to a fourth preferred embodiment of the present invention. The surface-mount connector 27 principally includes a second connecting part 271 and a sidewall 272, which are integrally formed into one-piece. The sidewall 272 is extended axially from a portion of the periphery of the second connecting part 271. The upper portion of the sidewall 272 is formed as a first connecting part 273. In addition, the first connecting part 273 of the surface-mount connector 27 has at least a protruding edge 274 extended outwardly from the upper peripheral of the sidewall 272, thereby increasing the contact area between the first connecting part 273 and the first circuit board 21.

Moreover, since the surface-mount connectors 27 of this embodiment are made of ductile material, the second connecting parts 271 of the relatively longer surface-mount connectors will be subject to deformation in response to a slight external force.

In accordance with a specific feature of the present invention, a slight external force may be applied on the second connecting parts 271 by means of a press tool after the upper surfaces of these surface-mount connectors 27 are bonded on the first circuit board 21. As a consequence, the height difference between any two surface-mount connectors is reduced and the surface-mount connectors 27 are nearly coplanar. Under this circumstance, the surface mount connector 27 may electrically and/or structurally interconnect the first circuit board 21 and the second circuit board 22, thereby increasing the product yield. The second connecting part 271 is a substantially a conductive surface of an arbitrary shape such as a rectangular shape, a circular shape, an elliptic shape or a polygonal shape. Alternatively, the protruding edge 274 may be dispensed with.

In the above embodiments, the second connecting part of the surface-mount connector may have a curved convex surface, as shown in FIGS. 2(b), 3(a) and 4(b). Due to capillary attraction, the solder paste will be naturally filled in a gap between the curved convex surfaces of the relatively shorter surface-mount connectors and the second circuit board. Nevertheless, as shown in FIG. 5(a), the second connecting part of the surface mount connector may have a flat surface as long as the relatively longer surface-mount connectors are subject to deformation in response to a slight external force.

From the above description, since the surface-mount connectors of the present invention are made of ductile material, the height difference between any two surface-mount connectors is reduced and the surface-mount connectors are nearly coplanar in response to a slight external force. As a consequence, the problem of causing poor solderability in the prior art is avoided and the product yield in increased. Moreover, the surface mount connectors of the present invention may electrically and/or structurally interconnect the first circuit board and the second circuit board, thereby increasing the product yield.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

1. A surface-mount connector for electrically interconnecting a first circuit board and a second circuit board, said surface-mount connector comprising:
a first connecting part to be bonded onto said first circuit board;
a second connecting part having a conductive surface to be bonded onto said second circuit board; and
a sidewall having a first end axially extended from a periphery of said second connecting part and a second end being formed as at least a portion of said first connecting part;
wherein said sidewall has an external surface and an internal surface and a space is defined by said internal surface.

2. The surface-mount connector according to claim 1 wherein said conductive surface is a curved convex surface protruded toward said second circuit board.

3. The surface-mount connector according to claim 1 wherein said first connecting part further includes at least a protruding edge for increasing a contact area between said first connecting part and said first circuit board.

4. The surface-mount connector according to claim 1 wherein said periphery of said second connecting part is fully surrounded by said sidewall such that said surface-mount connector is substantially a hollow cylindrical tube.

5. The surface-mount connector according to claim 1 wherein said periphery of said second connecting part is partially surrounded by said sidewall.

6. The surface-mount connector according to claim 1 wherein said sidewall is symmetrically extended from said periphery of said second connecting part.

7. The surface-mount connector according to claim 1 wherein said surface-mount connector is made of ductile conductive material.

8. The surface-mount connector according to claim 7 wherein said ductile conductive material is metallic material.

9. The surface-mount connector according to claim 8 wherein said metallic material is copper.

10. The surface-mount connector according to claim 1 wherein said surface-mount connector is bonded onto said first circuit board and said second circuit board via a connecting medium.

11. A circuit board assembly comprising:
a first circuit board;
a second circuit board; and
a plurality of surface-mount connectors arranged between said first circuit board and said second circuit board for electrically interconnecting said first circuit board and said second circuit board, each said surface-mount connector comprising a first connecting part, a second connecting part and a sidewall, wherein said first connecting part is bonded onto said first circuit board, said second connecting part includes a conductive surface bonded onto said second circuit board, and said sidewall has a first end axially extended from a periphery of said second connecting part and a second end being formed as at least a portion of said first connecting part, wherein said sidewall has an external surface and an internal surface and a space is defined by said internal surface, and said conductive surface of said second connecting part of said surface-mount connector is optionally subject to deformation so as to reduce the height difference between any two surface-mount connectors.

12. The circuit board assembly according to claim 11 wherein said conductive surface is a curved convex surface protruded toward said second circuit board.

13. The circuit board assembly according to claim 11 wherein said first connecting part further includes at least a protruding edge for increasing a contact area between said first connecting part and said first circuit board.

14. The circuit board assembly according to claim 11 wherein said periphery of said second connecting part is fully surrounded by said sidewall such that said surface-mount connector is substantially a hollow cylindrical tube.

15. The circuit board assembly according to claim 11 wherein said periphery of said second connecting part is partially surrounded by said sidewall.

16. The circuit board assembly according to claim 11 wherein said sidewall is symmetrically extended from said periphery of said second connecting part.

17. The circuit board assembly according to claim 11 wherein said surface-mount connector is made of ductile conductive material.

18. The circuit board assembly according to claim 17 wherein said ductile conductive material is metallic material.

19. The circuit board assembly according to claim 18 wherein said metallic material is copper.

20. The circuit board assembly according to claim 11 wherein said surface-mount connector is bonded onto said first circuit board and said second circuit board via a connecting medium.
